(19) United States
(12) Patent Application Publication
(10) Pub. No.: US 2026/0205681 A1
(43) Pub. Date: Jul. 16, 2026

(54) IMAGE CAPTURING APPARATUS, CONTROL METHOD THEREOF, AND STORAGE MEDIUM

(71) Applicant: CANON KABUSHIKI KAISHA, Tokyo (JP)

(72) Inventor: HIRONORI KAIDA, Kanagawa (JP)

(21) Appl. No.: 19/433,258

(22) Filed: Dec. 26, 2025

(30) Foreign Application Priority Data
Jan. 14, 2025 (JP) 2025-004946

(51) Int. Cl. H04N 23/63; H04N 23/617

(52) U.S. Cl. CPC H04N 23/632; H04N 23/617

(57) ABSTRACT

An image capturing apparatus includes an image capturing device that captures a subject, a presentation device that presents a shooting concept image in which a first image is modified, by using a learning model that has learned a user's preference of an image, based on the first image captured by the image capturing device, an operation device that performs an operation as to whether the user selects the shooting concept image or adjusts the shooting concept image, for an image presented by the presentation device, and a calculation unit that calculates a shooting parameter required for shooting an image corresponding to the shooting concept image selected by the user or a modified image adjusted by the user, by using the operation device.

### BACKGROUND

### Field of the Technology

The present disclosure relates to an image capturing apparatus having a shooting assist function.

### Description of the Related Art

A known image capturing apparatus such as a digital camera needs to make a user manually adjust many parameters such as shutter speed, aperture, and ISO sensitivity, in order to perform optimum setting in accordance with a shooting scene. This cumbersome operation makes it difficult for a user unfamiliar with shooting in particular to perform shooting as intended. Although there is an automatic mode (e.g., a program automatic function), this also does not guarantee optimum results in all situations.

Japanese Patent Laid-Open No. 2019-213130 discloses an image capturing apparatus that performs scene determination based on a result of performing learning on each shooting scene including a shooting parameter, and specifies the shooting scene. Then, a recommended camera setting item and an adjustment range thereof are displayed in accordance with the specified scene. This achieves a shooting assist technology in consideration of not only a recommended setting of a general camera but also an adjustment range of the user.

However, in the technology described in Japanese Patent Laid-Open No. 2019-213130, only a recommended camera setting item can be adjusted by the user, and therefore in a case where a result of scene determination does not match a user's preference, there is a possibility of making it difficult to achieve a shooting setting desired by the user. Furthermore, in a case where it is necessary to change a plurality of shooting setting items, there is a possibility that a plurality of setting items are displayed, and as a result, the user is forced to perform a complicated shooting setting operation.

### SUMMARY

The present disclosure has been made in view of the above-described problems, and provides an image capturing apparatus that enables a user to more easily perform a shooting setting desired by the user.

According to an aspect of the present disclosure, an image capturing apparatus comprising: an image capturing device that captures a subject; a presentation device that presents a shooting concept image in which a first image is modified, by using a learning model that has learned a user's preference of an image, based on the first image captured by the image capturing device; an operation device that performs an operation as to whether the user selects the shooting concept image or adjusts the shooting concept image, for an image presented by the presentation device; at least one processor or circuit and a memory storing instructions to cause the at least one processor or circuit to perform operations of the following units: a calculation unit that calculates a shooting parameter required for shooting an image corresponding to the shooting concept image selected by the user or a modified image adjusted by the user, by using the operation device.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views illustrating a configuration of a digital camera that is one embodiment of an image capturing apparatus of the present disclosure.

FIG. 2 is an external view of a digital camera.

FIG. 3 is a flowchart showing a change operation of a shooting setting.

FIG. 4 is a conceptual view for describing a change operation of a shooting setting.

FIG. 5 is a view illustrating a configuration of a generation unit 34 including one learning model.

FIG. 6 is a view illustrating a configuration of the generation unit 34 including three learning models.

FIG. 7 is a schematic diagram illustrating an example of an overall configuration of a CNN.

FIG. 8 is a schematic diagram illustrating an example of a detailed configuration of a CNN.

FIGS. 9A to 9C are views describing a method of determining a shooting style to be arranged on an adjustment bar.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

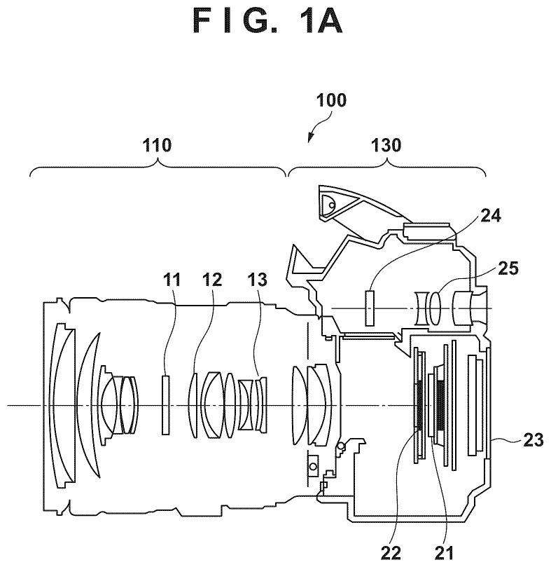

FIG. 1A is a view illustrating a mechanical configuration of a digital camera 100, which is one embodiment of an image capturing apparatus of the present disclosure. A shooting optical system 110 includes an aperture 11, a camera shake correction lens group 12, and a focus lens group 13, and can guide subject light to a camera body 130. The camera body 130 includes an image sensor 21 that photoelectrically converts an optical image formed by the shooting optical system 110 and a mechanical shutter 22 that adjusts an exposure time.

The camera body 130 includes a rear liquid crystal display 23 on a rear part, and a small liquid crystal display 24 and an optical system 25 on a finder unit 40, and can display an image captured by the image sensor 21. Note that the mechanical shutter is unnecessary as long as the image sensor includes an electronic shutter function, and even in a case where the image sensor includes a mechanical shutter, the mechanical shutter remains fully opened in a case where the exposure time is adjusted with the electronic shutter. At the time of shooting, a shutter button not illustrated is shallowly pressed to the first stage, that is, what is called “half-press” (hereinafter, called SW1 pressing), whereby automatic focus adjustment is performed, and shooting parameters such as a shutter speed and an aperture value are set by an automatic exposure mechanism. Furthermore, the shutter button is deeply pressed from half-press to the second stage, that is, what is called “full-press” (hereinafter, called SW2 pressing), whereby the electronic shutter function of the mechanical shutter 22 or the image sensor 21 operates to perform capturing.

FIG. 1B is a view illustrating an electrical configuration of the digital camera 100. The camera body 130 includes an electric circuit 30, and a CPU 31, an image processing unit 32, a control unit 33, a generation unit 34, a voice acquisition unit 35, and the like are arranged in the electric circuit 30. A memory 36 that stores image data, programs, and the like is connected to the electric circuit 30. The aperture 11, the camera shake correction lens group 12, the focus lens group 13, and the mechanical shutter 22 are each driven and controlled by the control unit 33 via a driving means not illustrated.

An image signal generated by photoelectric conversion in the image sensor 21 is output as digital data from the image processing unit 32 and stored in a recording medium not illustrated. The image processing unit 32 performs processing of recognizing a shooting scene from shot image data and processing of recognizing a feature of a shooting object.

The finder unit 40 further includes an eye contact sensor 26, and can detect whether or not a shooter has eye contact on the finder unit 40. The camera body 130 includes the voice acquisition unit 35, and can process voice input with a microphone 27. The generation unit 34 includes a neural network, and is a processing unit that generates a shooting concept image that is a new image from image data based on learning and a shooting parameter for shooting the shooting concept image. This will be described in detail below.

The CPU 31 is a processing apparatus that can electrically control all the above-described elements. In FIG. 1B, a control signal line is omitted, and only the flow of information between elements is indicated by an arrow.

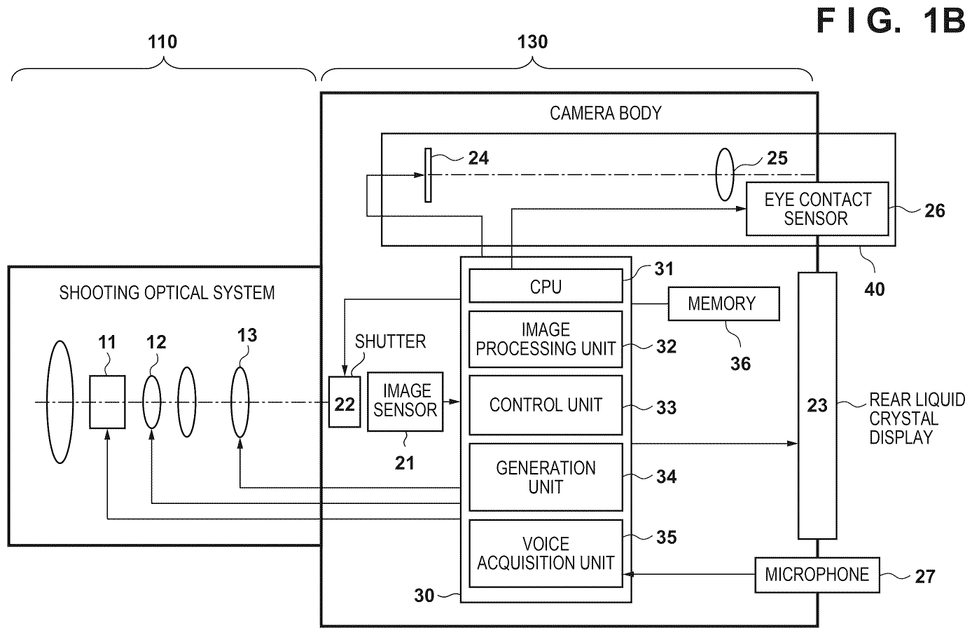

FIG. 2 is an external view of the digital camera 100. The same blocks as those in FIGS. 1A and 1B are denoted by the same reference signs.

The user changes the shooting parameter using an operation unit 202 and an electronic dial 204, which are setting changing means such as a button added to the image capturing apparatus, and performs shooting. Note that the rear liquid crystal display 23 may have a touch panel function, and the rear liquid crystal display 23 may allow a change of the shooting parameter. The user can ascertain a current setting status of the shooting parameter by display output by the rear liquid crystal display 23 or the small liquid crystal display 24. Adjustment, change, and the like regarding a generated image displayed by the rear liquid crystal display 23 or the small liquid crystal display 24, which is a display unit, are also performed by the electronic dial 204 and the operation unit 202.

Camera setting parameters constituting the shooting style vary widely. Shooting parameters for adjusting exposure include ISO sensitivity, aperture, shutter speed, and exposure correction value. White balance for adjusting the color tone, contrast value for enhancing and weakening the outline of the subject, aperture value for adjusting the depth of the subject, and the like are also representative shooting parameters. Of course, other shooting parameters that affect shot images may also be included.

Other than the shooting parameters cited above, shooting parameters may include information on focus positions in a case where preferences of photographs vary depending on users and it is desired to focus on any of a plurality of subjects, and in a case where it is desired to focus on a specific subject.

The generation unit 34 is a processing unit including a learning model that can present a shooting concept matching a user's preference in view of the user, the shooting situation, and the like in this manner, and the learning model includes, for example, a multilayer neural network.

In the present embodiment, the generation unit 34 learns the user's preference in advance before shooting with respect to the type of the lens, which is the shooting optical system 110, and the camera body 200, performs inference processing with a live view image before shooting as an input, and generates a shooting parameter. In other words, the generation unit 34 includes a learning model learned with a live view image as an input and with a shooting parameter for obtaining an image matching the user's preference for the image as supervisory data. Then, the shooting concept image and the shooting concept parameter are generated from the generated shooting parameters, and an adjustment screen on which the user can adjust the shooting concept image is output to the rear liquid crystal display 23 and the finder unit 40. A learning method will be described later.

Processing Flow from Shooting Concept Generation to Setting Change by Generation Unit 34

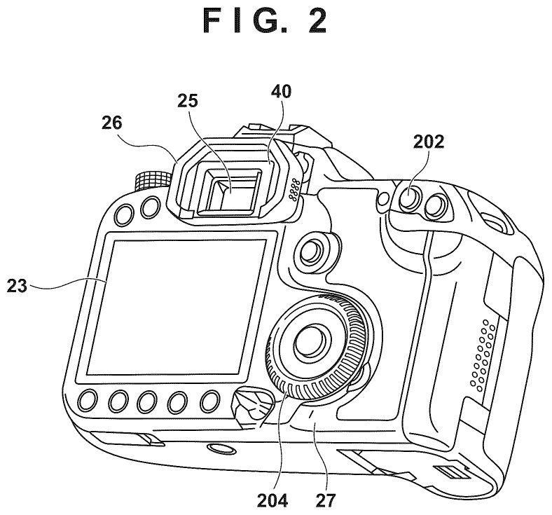

FIG. 3 is a flowchart showing processing regarding a setting change of the image capturing apparatus in the present embodiment. The flow of a setting change operation of the present embodiment will be described based on the flowchart. The following processing is implemented by the CPU 31 sending a command to the control unit 33 by executing a program stored in the memory 36 and controlling each unit of the apparatus.

Note that in the present embodiment, processing from generation of a shooting concept image to a setting change is started by detecting eye contact on the eye contact sensor 26. In the present embodiment, the small liquid crystal display 24 is hereinafter referred to as a display unit, and the rear liquid crystal display 23 or both the rear liquid crystal display 23 and the small liquid crystal display 24 may play a role as a display unit.

In step S301, the CPU 31 stores, in the memory 36, the live view image obtained from the image sensor 21.

In step S302, the CPU 31 generates and stores, in the memory 36, a plurality of shooting concept images and shooting parameters in accordance with a shooting style matching the user's preference based on the live view image stored in the memory 36 using the generation unit 34. It is possible not only to generate a shooting style directly from past learning but also to generate a shooting style including the current user's preference by reflecting a desire for the shooting style from a user's voice instruction.

When the user voices a desire for a shooting setting of the camera at the timing of step S302 for example, the CPU 31 performs voice recognition to transcribe the voice into text, and inputs the resulting prompt (the user's desire expressed in text) into the generation unit 34. Then, the generation unit 34 generates a shooting concept image matching the user's desire as an output of a learned model. Even if the user's desire for the shooting setting of the camera in this case is a vague desire with a high abstraction level, the generation unit 34 can generate an appropriate shooting concept image as an output of a model learned in advance. For example, in this case, the user make a voice utterance such as “I want to shoot with a shooting effect that makes a person stand out”.

In step S303, the CPU 31 displays, on the display unit such as the rear liquid crystal display 23 or the small liquid crystal display 24, an adjustment interface that allows the user to select any of the plurality of shooting styles generated in step S302.

In step S304, the CPU 31 displays, on the display unit such as the rear liquid crystal display 23 or the small liquid crystal display 24, the shooting concept image in accordance with the shooting style selected by the user in step S303.

In step S305, the CPU 31 determines whether or not the setting regarding the shooting concept image has been changed. Using the adjustment interface displayed in step S303, the user can change the shooting style matching the preference. Each shooting parameter in the shooting style can be changed. Details of the change of the shooting style will be described later. The change operation of the shooting style is performed using the operation unit 202 or the electronic dial 204. In a case where the change operation of this shooting style is performed, the CPU 31 advances the processing to step S306, and otherwise, advances the processing to step S307.

In step S306, the CPU 31 reads, from the memory 36, and displays, on the display unit, a modified image in which the shooting concept image is modified in accordance with the shooting style changed by the user in step S305.

In step S307, the CPU 31 determines whether or not the setting of the shooting condition is completed. In a case where the shooting concept image (modified image) becomes close to the user's desired shooting vision, the setting change ends by the user's operation. The operation regarding ending of the setting change is performed using the operation unit 202 or the electronic dial 204. In a case where the setting change ends, the CPU 31 advances the processing to step S308, and in a case where the shooting vision is still different from the user's desired shooting image, the processing returns to step S304. Then, the user performs the setting change operation again.

In step S308, the CPU 31 calculates a shooting condition for generating a shooting concept image in accordance with the user's desire. A calculation method will be described later.

In step S309, the CPU 31 sets, to the digital camera 100, the shooting condition calculated in step S308, and completes shooting preparation.

The processing flow from the generation of the shooting concept image to the setting change by the generation unit 34 has been described above with reference to the flowchart of FIG. 3.

In the present processing, the processing from step S305 to step S307 is repeated, whereby the process of updating the shooting concept image generated by the generation unit 34 is repeated, and the shooting style matching the user's preference is determined. Then, it is implemented that the camera sets the shooting condition based on the shooting concept image reflecting the user's preference.

In a known method, it is necessary to adjust a plurality of shooting conditions of the camera in order to match a user's preference shooting style, and the user has been forced to perform very complicated adjustment. However, according to the present embodiment, the user can adjust the shooting condition by an intuitive operation. Furthermore, complicated adjustment necessary for setting the shooting condition and direct operation of many setting items become unnecessary, and the shooting condition matching the user's preference can be easily set.

### Display Generated Image in Live View

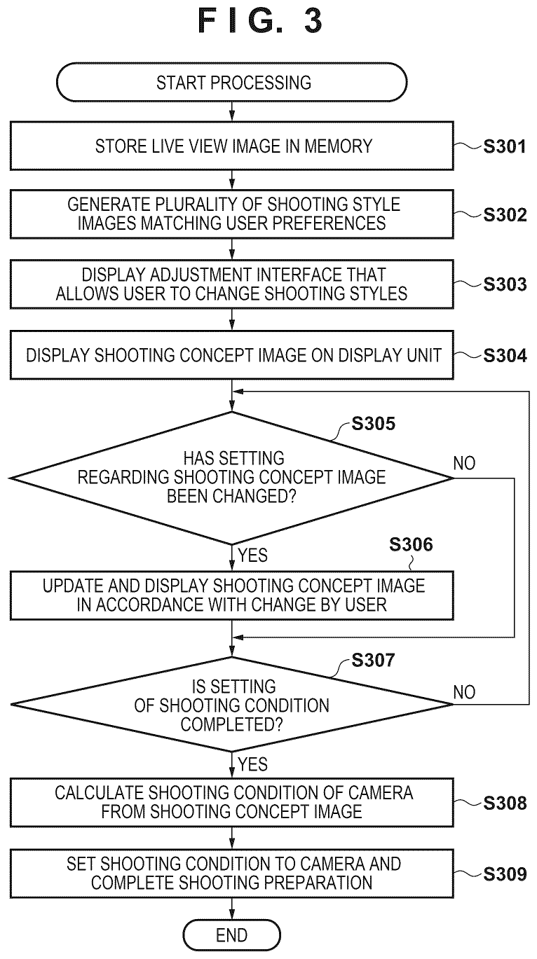

FIG. 4 is an operation conceptual view regarding a screen on which a setting operation is performed by displaying a shooting concept image performed by the display unit in the present embodiment. Images updated for each time series and processing will be described with reference to the conceptual view of FIG. 4.

As an example, FIG. 4 illustrates an example of a screen on which a setting operation is performed in a scene where portrait shooting is performed in a flower field. It illustrates a user confirming a live view image through the finder.

The figure illustrated along the time axis illustrates the display content of the small liquid crystal display 24 being viewed by the user through the finder, and illustrates that the shooting concept image displayed on the small liquid crystal display 24 is updated and displayed in time series by executing the processing of the flowchart shown in FIG. 3.

At the timing of time to, a live view image is shot under a shooting condition determined in accordance with an exposure condition calculated in a program auto (P) mode automatically set by the camera, and is displayed on the small liquid crystal display 24.

At the timing of time t1, a shooting concept image adjustment mode is started. At this time, the live view image is continuously displayed as a shooting concept image 405 as it is, and a bar 401 for adjusting the shooting style is displayed below the image. The bar 401 for adjusting the shooting style displays a setting adjustment marker 402 (diamond-shaped mark) representing the shooting style. This setting adjustment marker 402 (diamond-shaped mark) is a user adjustable user interface (UI) in which the position of the diamond-shaped mark indicates the shooting style currently adjusted, and the shooting style is expressed on the bar 401. The shooting concept image adjustment mode of FIG. 4 illustrates an example in which five shooting styles including a setting faithful to the camera can be switched.

The initial position of the bar 401 is the left end, and an initial position 403 is a faithful setting (small shooting effect). On the other hand, the shooting style farthest from the faithful setting (large shooting effect) is the shooting style positioned at the right end (position 404). Shooting styles shot by the user in the past are classified, those shooting styles are arranged on a scale on the adjustment bar 401 so as to increase a shooting effect from the setting faithful to the camera, and a UI in which the user can select the shooting style is created.

At time t1 when the shooting concept image adjustment mode is started, the setting adjustment marker 402 is displayed at the left end position 403 as a shooting style corresponding to the shooting concept image.

At times t2 and t3, the user confirms the shooting concept image (modified image) displayed on the display unit, and in a case where the current shooting style does not match the user's preference, moves the setting adjustment marker 402, and changes the shooting style to another shooting style. The generation unit 34 generates, as an output of the learned model, a shooting concept image matching the user's desire. The user's operation of changing the shooting setting of the camera at this time is only to move the setting adjustment marker 402 on the bar 401 to adjust whether to greatly change or slightly change the style from the image of the camera faithful setting, and an intuitive adjustment is possible. Furthermore, the setting can be performed while confirming the shooting concept image of the adjusted shooting style.

In other words, using the electronic dial 204 or the operation unit 202, the user moves the setting adjustment marker 402 in the range of 403 to 404 with respect to the shooting concept image 405. By moving the setting adjustment marker 402 to the position from 403 to 404, it is possible to instruct the generation unit 34 for a request to change to a shooting style that gives an effect with an extent far from the P mode setting of the camera.

At times t2 and t3, for example, in accordance with a user's adjustment, a shooting concept image in which a front subject is clearly shot by blurring a background subject (flower field) is displayed. At this time, the shooting concept images of the remaining four shooting style except the faithful setting marked on the adjustment bar 401 in advance may be stored in the memory 36 in advance, read, and displayed on the display unit. The generation unit 34 generates a shooting concept in real time regarding an unprepared shooting concept image. For example, in a case where the user performs adjustment of positioning between different shooting styles, a shooting concept image of the shooting style intermediate between the different shooting styles is newly generated. That is, use of the generation unit 34 can generate a shooting style that is not discrete but continuous.

At time t4, a shooting concept image 407 to which the shooting style set at the position of the adjustment bar 401 adjusted at time t3 is applied is displayed on the display unit. The shooting concept image 407 is a shooting concept image in which the depth of the background is made shallower and the entire subject is made brighter than the shooting concept image 405 at time t0.

At time t5, since the shooting concept image having the shooting style matching the user's preference can be confirmed, the user sends an adjustment completion instruction to the generation unit 34.

At time t6, in order to shoot an image with the shooting concept image finally set by the user, the generation unit 34 calculates the shooting setting parameter of the camera, and the camera shooting setting is completed via the control unit 33.

In this manner, the user moves the setting adjustment marker 402 until the desired shooting concept image is generated, and when a satisfactory shooting concept image is displayed, the user sends the adjustment completion instruction (time t5) to the generation unit 34.

The operation of displaying the shooting concept image and performing the setting operation that are performed by the generation unit 34 and the display unit in the present embodiment has been described above with reference to FIG. 4.

In the above description, an example of adjusting the shooting style so as to enhance the shooting effect by adjusting the setting adjustment marker 402 and adjusting the shooting style from the shooting concept image 405 to the shooting concept image 407 has been described. However, on the other hand, it is also possible to adjust the adjustment bar 401 so as to suddenly obtain a strong shooting effect and then to adjust it so as to gradually weaken the shooting effect.

For example, after instantly moving the setting adjustment marker 402 to 404 once, it is possible to change the setting adjustment marker 402 to a position between 403 and 404 so that the shooting effect of the shooting concept image 407 is weakened, and perform adjustment so as to reduce the shooting effect. By displaying the shooting concept image and performing the setting operation using the setting adjustment marker 402 in this manner, the user can intuitively adjust the shooting effect in accordance with the user's preference, and can achieve shooting of an image matching the user's preference more.

### Motion of Adjustment Marker

The update speed of displaying the shooting concept image on the display unit may be changed in accordance with the speed (operation speed) at which the user moves the setting adjustment marker 402. In a case where the user moves the setting adjustment marker 402 quickly, it is intended to greatly change the change in the effect, and therefore the update frequency of the shooting concept image is decreased. On the other hand, when the user is finely adjusting the setting adjustment marker 402, it indicates that the user desires to finely adjust the change in the effect of the shooting concept image, and therefore the update speed of the shooting concept image displayed on the display unit is increased. By changing the update speed of the shooting concept image in this manner, effects of power saving of the camera and reduction in the burden on the user to confirm the image are conceivable.

In a case where the user moves the setting adjustment marker 402 more slowly, in particular, in a case of moving it to a position between scales on the adjustment bar 401, the generation unit 34 may newly generate and display, on the display unit, a shooting style between the shooting styles corresponding to the scales. At this time, by generating a shooting concept image strongly affected by the shooting style corresponding to the scale whose position of the setting adjustment marker 402 is closer, the user can more finely adjust the position of the setting adjustment marker 402 on the adjustment bar 401.

Subsequently, creation of a shooting concept image and the configuration and learning of a generation model of a shooting parameter performed by the generation unit 34 will be described.

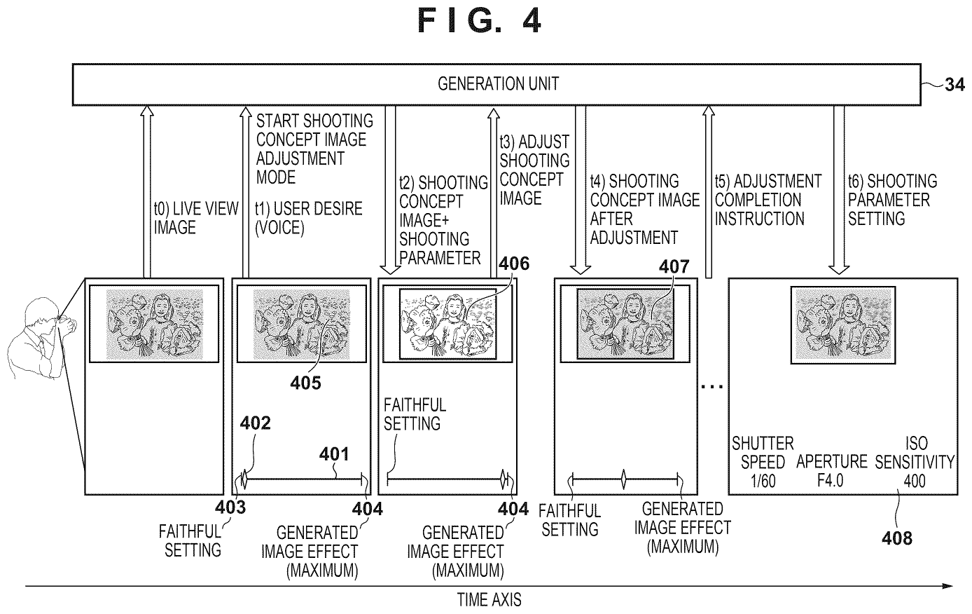

FIG. 5 is a view illustrating a configuration example of the generation unit 34 including one learning model. In FIG. 5, a camera type, a lens type, and a prompt indicating a user's preference are input data of a learning model, but a plurality of learning models may be prepared for camera types and lens types. As in FIG. 5, in a configuration in which both a shooting concept image and a shooting parameter are output from one learning model, the shooting concept image and the shooting parameter are closely related to each other and generated. Therefore, it is possible to obtain a result in which the shooting result when using the generated shooting parameter is closer to the shooting concept image. On the other hand, when one model is given a plurality of tasks, the model scale generally increases, and the processing time tends to increase.

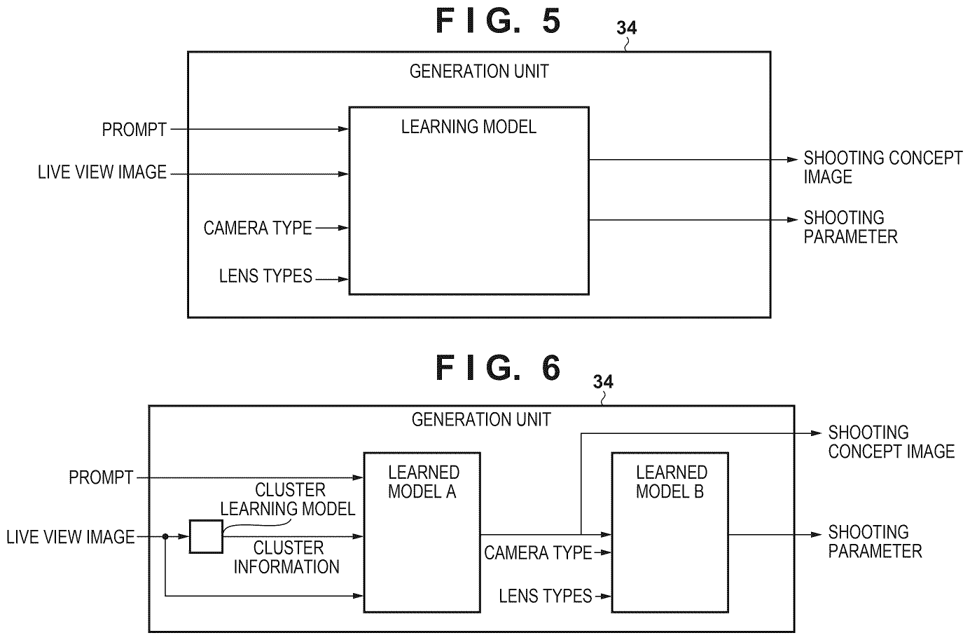

Next, FIG. 6 is a view illustrating a configuration example of the generation unit 34 including three learning models. Unlike FIG. 5, the output of each learning model is clearly separated, the model scale is reduced, and the processing time is prioritized. First, a live view image is input to a cluster learning model, the subject of a scene to be shot is analyzed, cluster classification is performed, and cluster information indicating which learned cluster the live view image belongs to is output. Thereafter, the cluster information, live view information, and (if necessary, a prompt) are input to a learning model A, and a shooting concept image is output. Next, in a learning model B, a shooting parameter is calculated based on the shooting concept image already output. Doing this enhances the accuracy of the generation result of each generation unit 34, and therefore the configuration of FIG. 6 is used in the present embodiment. Of course, the present disclosure is not limited to this, and the configuration of FIG. 5 may be used.

### Generation of Optimum Shooting Parameters Based on Data Learned in Past

Subsequently, a learning method of the present embodiment will be described.

Since the generation unit 34 of the present embodiment finally derives a shooting parameter, it is necessary to calculate the shooting parameter based on the feature of equipment. The user's desire needs to be also reflected as a prompt (as input data) in the shooting concept image and the shooting parameter based thereon.

Therefore, as a learning model to be a base used by the generation unit 34, a model that uses information on the camera and the lens as input data and can perform inference processing unique to each camera and lens is used. Since it is necessary to generate a shooting concept image in accordance with the user's preference by using a prompt, separately from the learning of the shooting concept image and the shooting parameter, learning of performing syntax analysis of the prompt and determining information regarding the shooting condition is also completed in advance.

It is assumed that in the initial state of the learning model, learning is performed so as to output a shooting concept generally considered appropriate in which learning is repeated using a large amount of sample images as supervisory data. Furthermore, a sample image in which an output of a model having learned a prompt is also added as an input is also added as supervisory data. In other words, with the information on the camera and the lens and the prompt as input data, and with a registered image registered in advance as an image matching the user's preference as supervisory data, the learning model used by the generation unit 34 is caused to learn the user's preference. Note that the above-described registered image may be prepared by the shooter himself/herself or may be presented from the generation unit 34. The present embodiment assumes that the image presented by the generation unit 34 is selected by the user and thus registered.

The registered content is not necessarily limited to one. The present embodiment assumes that the generation unit 34 prepares a next option in order to narrow down the user's preference from the registered image that is the first registration information, and further prompts the user to select. This can be continued until the preference is narrowed down. The user may instruct ending of the registration up to selection halfway.

By collecting information in this manner and performing learning by the generation unit 34, it is possible to generate a shooting concept closer to the user's preference compared with the initial state.

Note that in the present embodiment, the registration information is an image, but the present disclosure is not limited to this, and a question format by characters may be used.

However, the description so far is merely an initial setting. In practice, many images are shot from this initial setting state, but it is effective to use also a result of this shooting for learning by the generation unit 34. Since the user selects the shooting concept generated by the generation unit 34 illustrated in the present embodiment and repeats shooting and input of a prompt, the adopted shooting concept image is also used as a learning image of the generation unit 34. Doing this can generate a learning model in further consideration of the user's preference.

A time series inference flag may be further given as input information, and whether to learn a past user's shooting concept image may be selected. In order to handle a case where it is not necessarily desired to cause time series inference, the present embodiment assumes that the user can instruct the generation unit 34 in advance whether or not to take over the information at the time of generating the immediately preceding shooting concept image. Note that the present disclosure is not limited to this, and the learning model of the generation unit 34 may be configured to self-determine whether or not to perform time series inference, or may be a learning model that fixedly always performs time series inference.

Note that the user may further select an image to be used for learning from among shooting concept images.

As described above, in the present embodiment, it is possible to generate a shooting concept image and a shooting parameter for implementing the shooting concept image based on an image before shooting, display the shooting concept image, and change the shooting parameter for implementing the shooting concept image by the operation unit. This can provide a shooting assist function suitable for the user.

In the present embodiment, the electronic dial 204 and the operation unit 202 are used to select and determine the shooting concept. With this operation, it is possible to select a shooting concept most suitable for the preference and perform shooting while viewing a live view image, referring to a shooting concept image displayed in an overlapping manner, and switching and comparing shooting concept images.

However, the generation timing of the shooting concept image by the generation unit 34 is not limited to the detection timing of the eye contact sensor 26, and the generation processing may be continuously performed from the timing at which acquisition of the live view image is started.

### Display Setting Parameter and Shooting Concept Image Based on Cluster Information

Next, a classification method of the shooting style will be described in detail.

In a case where a shooting style in which the user's preference is learned is classified into clusters, cluster classification of the shooting style is performed by classifying an image group having similar features with respect to an image shot in accordance with the user's preference in the past. In order to classify the shooting style, it is generally necessary to perform classification in accordance with various elements such as a feature of a subject appearing in a shot image and a shooting condition. Here, an example of performing cluster classification by performing subject detection and detecting a feature amount will be described as an example. However, the present disclosure is not limited to this, and any convolutional neural network (CNN) using a machine learning technology can be applied to the present disclosure.

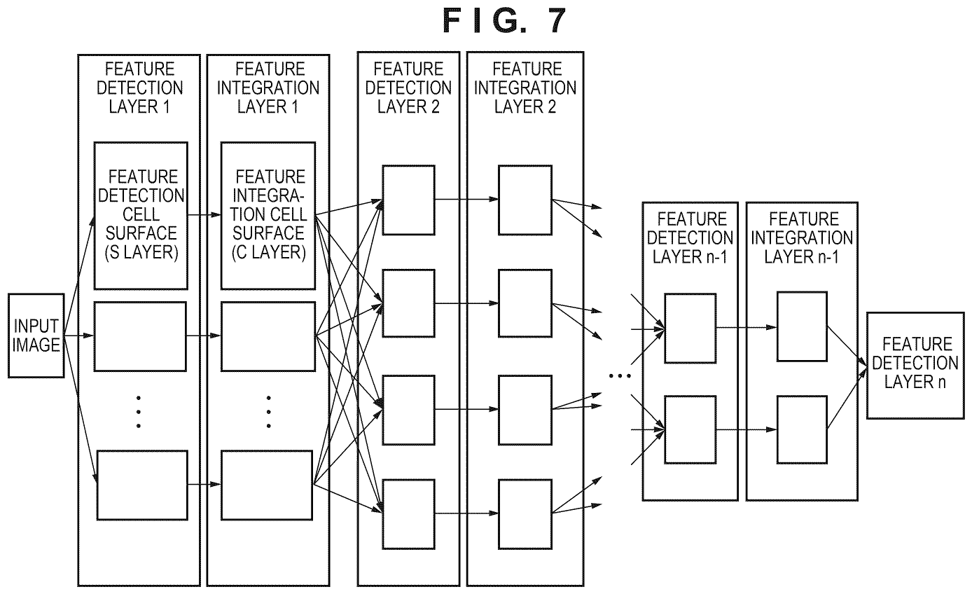

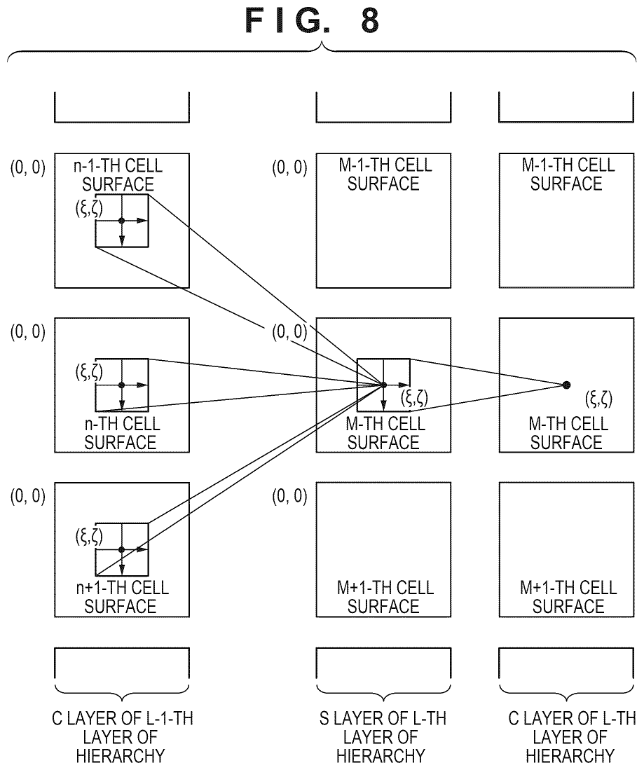

In order to perform cluster classification, the cluster learning model of FIG. 6 described above is used. FIGS. 7 and 8 illustrate submodules of the cluster learning model of FIG. 6.

FIG. 7 is a view illustrating a basic configuration of the CNN that detects a subject from two-dimensional image data having been input. In the flow of processing, the left end is input, and the processing proceeds in the right direction. In the CNN, two layers called a feature detection layer (S layer) and a feature integration layer (C layer) are one set, and are hierarchically configured.

In the CNN, first, the next feature is detected based on the feature detected in a preceding layer of hierarchy in the S layer. The CNN has a configuration in which the feature detected in the S layer is integrated in the C layer and sent to the next layer as a detection result in the layer of hierarchy.

The S layer includes a feature detection cell surface which detects different features for the feature detection cell surfaces. The C layer includes a feature integration cell surface which performs pooling of the detection results from the preceding feature detection cell surfaces. In the following, the feature detection cell surface and the feature integration cell surface are collectively referred to as a feature surface, if they need not to be particularly distinguish from each other. In the present embodiment, an output layer that is the final layer of hierarchy includes only the S layer without using the C layer.

Details of feature detection processing on the feature detection cell surface and feature integration processing on the feature integration cell surface will be described with reference to FIG. 8. The feature detection cell surface includes a plurality of feature detection neurons, and the feature detection neurons are connected to the C layer of the preceding layer of hierarchy with a predetermined structure. The feature integration cell surface includes a plurality of feature integration neurons, and the feature integration neurons are connected to the S layer of the same layer of hierarchy with a predetermined structure. In the M-th cell surface of the S layer of the L-th layer of hierarchy illustrated in FIG. 8, the output value of the feature detection neuron at a position (ξ, ζ) is expressed as y^{LS}_{M} (ξ, ζ), and in the M-th cell surface of the C layer of the L-th layer of hierarchy, the output value of the feature integration neuron at the position (ξ, ζ) is expressed as y^{LC}_{M} (ξ, ζ). At that time, when connection coefficients of the respective neurons are w^{LS}_{M} (n, u, v) and w^{LC}_{M} (u, v), each output value can be expressed as follows.

$${y}_{M}^{LS} ( ξ , ζ ) ≡ f ( {u}_{M}^{LS} ( ξ , ζ ) ) ≡ f \{ {\sum }_{n , u , v} {w}_{M}^{LS} ( n , u , v ) \cdot {y}_{n}^{L - 1 C} ( ξ + u , ζ + v ) \} \qquad ( Formula 1 )$$

$${y}_{M}^{LC} ( ξ , ζ ) ≡ {u}_{M}^{LC} ( ξ , ζ ) ≡ {\sum }_{u , v} {w}_{M}^{LC} ( u , v ) \cdot {y}_{M}^{LS} ( ξ + u , ζ + v ) \qquad ( Formula 2 )$$

fin Formula 1 is an activation function, and may be any sigmoid function such as a logistic function or a hyperbolic tangent function, and may be realized by, for example, a tanh function. u^{LS}_{M} (ξ, ζ) is an internal state of the feature detection neuron at the position (ξ, ζ) in the M-th cell surface of the S layer of the L-th layer of hierarchy. Formula 2 takes a simple linear sum without using an activation function. In a case where the activation function is not used as in Formula 2, an internal state u^{LC}_{M} (ξ, ζ) of the neuron and an output value y^{LC}_{M} (ξ, ζ) are equal to each other. y^{L-1C}ₙ (ι+u, ζ+v) of Formula 1 and y^{LS}_{M} (ξ+u, ζ+v) of Formula 2 are called connection destination output values of the feature detection neuron and the feature integration neuron, respectively.

ξ, ζ, u, v, and n in Formula 1 and Formula 2 will be described. The position (ξ, ζ) corresponds to position coordinates in the input image, and for example, in a case where y^{LS}_{M} (ξ, ζ) is a high output value, it means that there is a high possibility that a feature to be detected in the M-th cell surface of the S layer of the L-th layer of hierarchy exists at the pixel position (ξ, ζ) of the input image. In Formula 2, n means an n-th cell surface in the C layer of the L−1-th layer of hierarchy, and is called an integration destination feature number. Basically, a multiply-accumulation operation is performed for all the cell surfaces in the C layer of the L−1-th layer of hierarchy. (u, v) is a relative position coordinate of the connection coefficient, and a multiply-accumulation operation is performed in a finite range (u, v) in accordance with the size of the feature to be detected. Such a finite (u, v) range is called a receptive field. The size of the receptive field is hereinafter referred to as the receptive field size, and is expressed by the number of horizontal pixels×the number of vertical pixels in the coupled range.

In Formula 1, in L=1, that is, in the first S layer, y^{L-1C}ₙ (ξ+u, ζ+v) is an input image y^{in_image} (ξ+u, ζ+v) or an input position map y^{in_posi_map} (ξ+u, ζ+v). The neurons and the pixels are discretely distributed, and the coupling destination feature numbers are also discrete, and thus ξ, ζ, u, v, and n are not continuous variables, but are discrete values. Here, ξ and ζ are non-negative integers, n is a natural number, and u and v are integers, all of which are in a limited range.

w^{LS}_{M} (n, u, v) in Formula 1 is a connection coefficient distribution for detecting a predetermined feature, and it is possible to detect the predetermined feature by adjusting the connection coefficient distribution to an appropriate value. Adjustment of this connection coefficient distribution is learning, and in construction of the CNN, various test patterns are presented to repeatedly gradually modify the connection coefficient so that y^{LS}_{M} (ξ, ζ) becomes an appropriate output value, whereby the connection coefficient is adjusted.

Next, w^{LC}_{M} (u, v) in Formula 2 uses a two-dimensional Gaussian function and can be expressed as the following Formula 3.

$${w}_{M}^{LC} ( u , v ) = \frac{1}{2 π {σ}_{L , M}^{2}} exp ( - \frac{{u}^{2} + {v}^{2}}{2 {σ}_{L , M}^{2}} ) \qquad ( Formula 3 )$$

Also here, since (u, v) is a finite range, similarly to the description of the feature detection neuron, the finite range is called a reception field, and the size of the range is called a reception field size. Here, this receptive field size may be set to an appropriate value in accordance with the size of the M-th feature of the S layer of the L-th layer of hierarchy. In Formula 3, σ is a feature size factor, and may be set to an appropriate constant in accordance with the receptive field size. Specifically, it is preferable to set the outermost value of the receptive field to a value that can be regarded as substantially 0. An operation as described above is performed in each layer of hierarchy. Therefore, in the S layer of the final layer of hierarchy, a cluster classification result in accordance with the shooting style is obtained.

### Display Setting Parameter and Shooting Concept Image Based on Cluster Information

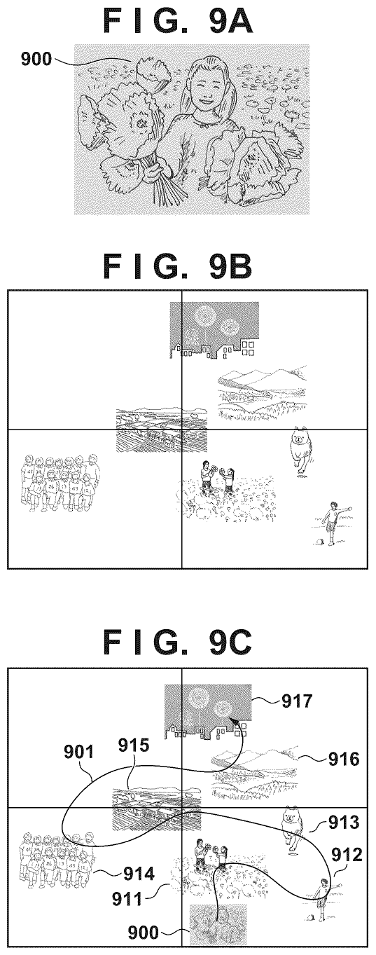

Subsequently, the arrangement of the shooting style set on the scale on the adjustment bar 401 will be described. Regarding the feature amount at the time of performing the cluster classification described above, the output of a feature integration layer n−1 as an intermediate output can be a feature amount for separating the shooting style. The shooting style preferred by the user is calculated by a previous learning result. Thereafter, the live view image acquired in step S301 of FIG. 3 is input to the learned CNN model in accordance with the shooting timing of the user, and the feature amount is calculated. By this, the feature amount of the shooting scene is determined, and the order of the shooting styles arranged on the adjustment bar 401 is changed. Description will be made with reference to the conceptual views of FIG. 9A to 9C.

An image 900 in FIG. 9A is an image shot in step S301 of FIG. 3. FIG. 9B is a cluster classification map plotted based on the feature amount in a case where a learning operation is performed by the CNN. In the cluster classification map, cluster classification is performed in advance for an image group in which user's preference has been learned, and images that are representative of the respective clusters are plotted based on two-dimensional feature amounts in the horizontal direction and the vertical direction. FIG. 9C is a cluster classification map in which feature amounts of the image 900 are calculated and plotted with respect to the cluster classification map of FIG. 9B.

In a case of arranging the shooting style matching the user's preference on the scale on the adjustment bar 401 from the shooting style close to the image of 900, it may arrange, on the scale on the adjustment bar 401 in order, the shooting style having the feature amount close to the position of the image 900 arranged in the cluster classification map of FIG. 9C. For the closeness of the feature amount at this time, there are various calculation methods, and as an example, a Euclidean distance is calculated, and a shooting style whose distance is close is selected in order. 901 denotes selection in order of closeness of the feature amount from the image 900. For example, there is a high possibility that the shooting style of 917, which is greatly away from the image 900, is not used as a shooting style because the scene of the image 900 and the configuration of the subject are greatly different. Therefore, in the scene of the image 900 taken at the time of shooting, it is not set as the scale of the adjustment bar 401. In the present embodiment, four shooting styles 911, 912, 913, and 914 close to the image 900 are arranged on the scale of the adjustment bar 401.

The shooting style to be arranged on the scale of the adjustment bar 401 in accordance with the shooting scene has been described above. In this manner, the shooting style to be arranged on the scale of the adjustment bar 401 changes in accordance with the scene to be shot.

As described above, according to the present embodiment, even a user unfamiliar with shooting can easily take a photograph as intended by the user. Since the shooting parameter is automatically generated by a machine learning algorithm, an optimum setting for each shooting scene is proposed, and the quality of the shooting result can be improved.

Note that the present disclosure is not limited to the above embodiment.

For example, in the above embodiment, an example in which a shooting concept image is displayed and the user operates the setting adjustment marker 402 has been described. However, it is also possible to move the setting adjustment marker 402 left and right without displaying a shooting concept image, and generate a shooting parameter in which a shooting effect is adjusted by the generation unit 34 in accordance with the position of the marker. Even if the shooting concept image is not displayed to the user through the display unit, the configuration of the model generates a shooting parameter related to the shooting concept image, and therefore it is not necessarily essential to present the shooting concept image to the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-004946, filed Jan. 14, 2025, which is hereby incorporated by reference herein in its entirety.

What is claimed is:

1. An image capturing apparatus comprising:
an image capturing device that captures a subject;
a presentation device that presents a shooting concept image in which a first image is modified, by using a learning model that has learned a user's preference of an image, based on the first image captured by the image capturing device;
an operation device that performs an operation as to whether the user selects the shooting concept image or adjusts the shooting concept image, for an image presented by the presentation device;
at least one processor or circuit and a memory storing instructions to cause the at least one processor or circuit to perform operations of the following units:
a calculation unit that calculates a shooting parameter required for shooting an image corresponding to the shooting concept image selected by the user or a modified image adjusted by the user, by using the operation device.

2. The image capturing apparatus according to claim 1, wherein the presentation device is a display device that displays the shooting concept image.

3. The image capturing apparatus according to claim 2, wherein the display device is a display apparatus arranged at a finder of the image capturing apparatus or a display device arranged on a rear surface of the image capturing apparatus.

4. The image capturing apparatus according to claim 2, wherein the operation device can adjust the shooting concept image by using a user interface for a user to adjust the shooting concept image, the user interface being displayed on the display device.

5. The image capturing apparatus according to claim 4, wherein the user interface includes a bar indicating an adjustment amount of the shooting concept image, and a marker movable along the bar.

6. The image capturing apparatus according to claim 2, wherein the display device displays the modified image that has been adjusted, along with adjustment of the shooting concept image.

7. The image capturing apparatus according to claim 1, wherein the at least one processor or circuit is configured to further function as
a control unit that performs control so as to repeat presentation of the modified image adjusted by the user and further adjustment of the modified image by the user using the operation device.

8. The image capturing apparatus according to claim 7, wherein the presentation device changes an update speed of presentation of the modified image in accordance with an operation speed of a user's adjustment by the operation device.

9. The image capturing apparatus according to claim 8, wherein the presentation device decreases an update speed of presentation of the modified image as an operation speed of a user's adjustment by the operation device increases.

10. The image capturing apparatus according to claim 1, wherein the operation device can adjust the shooting concept image based on a voice instruction from a user.

11. The image capturing apparatus according to claim 10, wherein the learning model further learns a user's preference based on a voice instruction from a user.

12. A control method of an image capturing apparatus including an image capturing device that captures a subject, the control method comprising:
presenting a shooting concept image in which a first image is modified, by using a learning model that has learned a user's preference of an image, based on the first image captured by the image capturing device;
performing an operation as to whether the user selects the shooting concept image or adjusts the shooting concept image, for an image presented by the presenting; and
calculating a shooting parameter required for shooting an image corresponding to the shooting concept image selected by the user or a modified image adjusted by the user, in the operation.

13. A non-transitory computer-readable storage medium storing a program for causing a computer to function as each unit of an image capturing apparatus, the image capturing apparatus comprising:
an image capturing device that captures a subject;
a presentation device that presents a shooting concept image in which a first image is modified, by using a learning model that has learned a user's preference of an image, based on the first image captured by the image capturing device;
an operation device that performs an operation as to whether the user selects the shooting concept image or adjusts the shooting concept image, for an image presented by the presentation device; and
a calculation unit that calculates a shooting parameter required for shooting an image corresponding to the shooting concept image selected by the user or a modified image adjusted by the user, by using the operation device.
